(19) United States
(12) Patent Application Publication
(10) Pub. No.: US 2018/0197221 A1
(43) Pub. Date: Jul. 12, 2018

(54) SYSTEM AND METHOD OF IMAGE-BASED SERVICE IDENTIFICATION

(71) Applicant: DRAGON-CLICK CORP., Parkland, FL (US)

(72) Inventor: Isaac Grossman, Parkland, FL (US)

(21) Appl. No.: 15/605,624

(22) Filed: May 25, 2017

Related U.S. Application Data
(60) Provisional application No. 62/443,331, filed on Jan. 6, 2017.

(51) Int. Cl. G06Q 30/06; G06Q 10/10; G06F 3/0482

(52) U.S. Cl. CPC G06Q 30/0621; G06F 3/0482; G06Q 10/1095; G06Q 30/0625

(57) ABSTRACT

Methods and systems are described for automatically identifying and presenting to a user products or services related to an electronic image identified by the user. The products or services may further be related to a user selection of an object within the image. The image may be obtained from a web site accessed by the user, or the image may be captured by the user via a camera of a mobile device. The image or mobile device may be associated with a geographic location, which may be used to further improve product or service search accuracy. Labels associated with aspects of the image may be generated and used to further identify keywords for searching products or services. Genres may be determined from the keywords to identify vendors or order options to search. The search results may be presented to the user as options related to relevant products or services.

### CROSS-REFERENCE TO RELATED APPLICATIONS

This application claims the benefit of provisional U.S. Patent Application No. 62/443,331, filed on Jan. 6, 2017, the entirety of which is incorporated herein by reference.

### TECHNICAL FIELD

The present disclosure generally relates to a tool for improving user experience in computer-aided identification and acquisition of products or services by automatically identifying objects within user-selected electronic images and presenting the user with options relating to products or services associated with the identified object.

### BACKGROUND

Consumer purchasing decisions are frequently driven by observation of products or services, either in showrooms or in actual use. For this reason, online sellers frequently include images of their products or images associated with their services. To obtain the best products for their uses at the best prices, customers frequently compare observed items with the same or other similar goods being sold by the same or other sellers. When a customer is within a physical shop, the customer may scan an identifying tag (e.g., a UPC barcode on a tag) of the item to search for identical items at other locations. Similarly, the user may enter an identifying description of the item into a smartphone to search for the same or similar products. Currently, users may likewise search for products they see or services sought on web sites of online retailers or otherwise, using keywords generated by the user based upon the user's familiarity with the subject matter. This presents a significant problem when a user is unfamiliar with a type of product, lacks information regarding details of available services, or cannot recall necessary details. Additionally, seemingly trivial variations in phrasing (e.g., “hat” or “cap”) can yield significantly different results, further complicating user-directed searching. Even when a user is able to accurately and fully describe a product, entering the description into a search engine may be time-consuming—particularly if the user attempts to fully specify all salient features of the product. The time required for a user to enter such information may be greater still if the user attempts to enter a lengthy search on the small screen of a smartphone. The various embodiments of the invention described herein avoid these inconveniences and delays.

### SUMMARY

The systems and methods disclosed herein generally relate to improvements to searches for products or services. The identification of products or services may be used to facilitate electronic commerce transactions by presenting options to a user, which may be purchase options for acquiring the identified products or services. The techniques involve identifying relevant keywords based upon an image. The image may be analyzed using computer image recognition techniques to generate labels associated with the image. In some embodiments, labels associated with objects indicated by the user within the image may be identified. Keywords may then be identified from the labels associated with the image, which keywords may be refined or filtered to identify particularly salient keywords. The keywords may be used to search information associated with vendors, such as web sites associated with product sellers or service providers. Data from sites matching the keywords may be used to generate datasets of information relating to options for acquiring the relevant products or services. Such options may then be presented to the user for selection. Upon user selection of an option, purchase or scheduling of the selected product or service may be automatically facilitated.

The present application discloses a method, system, and computer-readable medium storing instructions for facilitating electronic commerce by automated image-based searching. In some embodiments, the method, system, or instructions may further cause or facilitate purchasing or scheduling related products or services by presenting options relating to products or services to a user, which may include options. One embodiment includes a computer-implemented method including the following: obtaining an electronic image including a representation of an object within the image; identifying a plurality of labels associated with the image, wherein at least one of the labels is associated with the object; identifying a plurality of keywords associated with the electronic image based upon the plurality of labels; generating an option dataset containing a plurality of data entries indicating options based upon the plurality of keywords, each option being associated with a service; and/or causing one or more of the options indicated by the data entries to be presented to a user for review. The services may include one or more of the following types of services: entertainment services, maintenance services, or personal services.

In some embodiments, the method may include identifying a location associated with the user. Such location may be used in selecting the one or more options to be presented to the user based upon the identified location. The location associated with the user may be identified by identifying a location associated with the electronic image based upon location metadata associated with the electronic image, in some embodiments. In further embodiments, one or more vendor sites may be identified as being associated with vendors providing services within a geographic area associated with the location. The one or more vendor sites may then be searched for information regarding the service to identify the one or more options.

In further embodiments, a type of the object may be identified based upon the plurality of labels. In such embodiments, one or more of the labels may be an image object label describing the object. Generating the option dataset may then include: searching one or more vendor sites for information regarding services associated with the identified type of the object, and storing at least part of the information regarding the services from the one or more vendor sites in the option dataset. In related embodiments, an indication may be received from the user of a location within the electronic image, which location may be associated with the object. The object may then be identified at least in part based upon a user selection of a location within the image.

In yet further embodiments, an indication of a user selection of one of the one or more options may be received from the user. When such indication is received, a message based upon the user selection may be communicated to a vendor server associated with the option indicated by the user selection to cause a service appointment to be scheduled for the user.

Systems or computer-readable media storing instructions for implementing all or part of the system described above may also be provided in some aspects. Systems for implementing such methods may include one or more of the following: a mobile computing device (e.g., a smartphone, notebook computer, or tablet computer), a personal computer (e.g., a desktop computer, notebook computer), a workstation computer, a wearable computer (e.g., a smart watch, smart glasses, or virtual reality system), a remote server, a group of servers (e.g., a server cluster or a cloud computing servers), and/or other computing devices. Systems for implementing the methods may further include communication components for exchanging electronic data via communication networks. Additional or alternative features described herein below may be included in some aspects.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary object identification system on which the methods described herein may operate in accordance with the described embodiments;

FIG. 2 illustrates a block diagram of an exemplary communication system associated with the exemplary object identification system;

FIG. 3 illustrates a flow diagram of an exemplary object identification and purchase option presentation method in accordance with the embodiments described herein;

FIG. 4 illustrates an exemplary user selection of a location associated with an object within an electronic image;

FIGS. 5A-B illustrate exemplary displays of object information within an electronic image in accordance with the embodiments described herein;

FIG. 6 illustrates a flow diagram of an exemplary object identification method in accordance with the embodiments described herein;

FIG. 7 illustrates an exemplary plurality of grids for use with the exemplary object identification method in accordance with the embodiments described herein;

FIG. 8 illustrates a flow diagram of an exemplary purchase option generation method for automatically generating lists of purchase options in accordance with the embodiments described herein;

FIG. 9 illustrates a flow diagram of an exemplary genre-based search method in accordance with the embodiments described herein; and

FIG. 10 illustrates a flow diagram of an exemplary service identification method in accordance with the embodiments described herein.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

As used herein, the term “object” means any tangible thing that can be identified within an electronic representation of a physical environment. Examples include, without limitation, the following: a vehicle, person, shirt, tree, or building represented within an electronic image file. As used herein, the term “product” means any object of a type that may be acquired by purchase from a seller or other vendor. Examples include, without limitation, the following: clothing, jewelry, electronics, furniture, mass-produced decorative art, mass-produced packaged food or beverages, vehicles, etc. As used herein, the term “service” means any commercial service that may be obtained from a service provider or other vendor. Examples include, without limitation, the following: entertainment services (e.g., admission to sporting events, theatrical performances, or musical performances), maintenance services (e.g., automobile maintenance or home repair), personal services (e.g., medical services, hairstyling, or financial advising), or other types of services (e.g., business services or governmental services). As used herein, the term “genre” means any category, class, type, or grouping of products or services having sufficiently similar attributes relevant to be commercial substitutes for some consumers. Although the systems and methods described herein may be described as relating to purchase options for clarity and conciseness, other related options (e.g., rental options, lease options, sale options, etc.) may be identified and used in some embodiments.

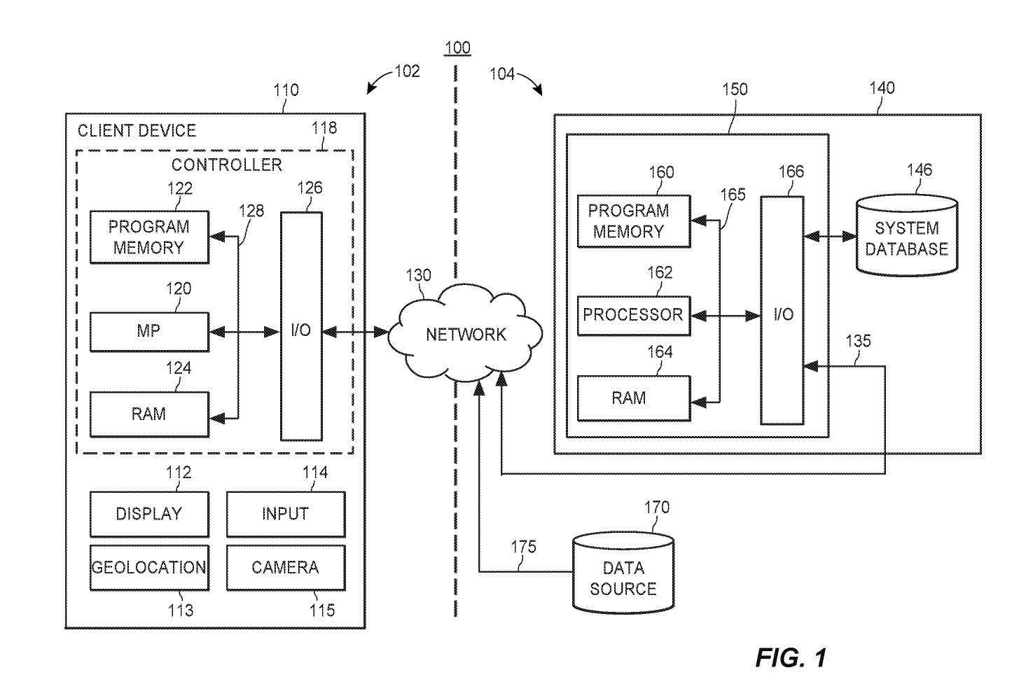

FIG. 1 illustrates a block diagram of an exemplary object identification system 100. The high-level architecture includes both hardware and software applications, as well as various data communications channels for communicating data between the various hardware and software components. The object identification system 100 may be roughly divided into front-end components 102 and back-end components 104. The front-end components 102 allow a user to capture or select images, indicate objects within images, view purchase or other options, and/or purchase products or services via a client computing device 110. The front-end components 102 may communicate with the back-end components 104 via a network 130. The back-end components 104 may use one or more servers 140 to process the data provided by the front-end components 102 and other sources to identify objects or object labels, search for options (such as purchase options), and/or provide information to the client computing device 110. The server 140 may store and retrieve data within a database 146. Additionally, or alternatively, the server 140 may request or receive information from one or more data sources 170, which may be associated with vendors selling products or services. For example, the data sources 170 may be associated with online retailers selling products associated with an object identified in an electronic image, as described further elsewhere herein.

The front-end components 102 may be disposed within one or more client computing devices 110, which may include a desktop computer, notebook computer, netbook computer, tablet computer, or mobile device (e.g., a cellular telephone, smart phone, wearable computer, etc.). The client computing device 110 may include a display component 112, a geolocation component 113, an input component 114, a camera 115, and a controller 118. The display component 112 may be a display screen integrated into or connected to the client computing device 110. The geolocation component 113 may include a global positioning system (GPS) receiver configured to generate geolocation data indicating the location of the client computing device 110. The input component 114 may include an external hardware keyboard communicating via a wired or a wireless connection (e.g., a Bluetooth keyboard), an external mouse, or any other suitable user-input device. In some embodiments, the input component 114 may be combined with or integrated into the display 112, such as a touchscreen display or a “soft” keyboard that is displayed on the display 112 of the client computing device 110. The camera 115 may be a digital camera configured to capture still and/or video images, which may be stored or displayed by the client computing device 110.

The controller 118 includes one or more microcontrollers or microprocessors (MP) 120, a program memory 122, a RAM 124, and an I/O circuit 126, all of which are interconnected via an address/data bus 128. The program memory 122 may include an operating system, a data storage, a plurality of software applications, and a plurality of software routines. The program memory 122 may include software applications, routines, or scripts for implementing part or all of the methods described herein, including communicating with the server 140 via the network 130. In some embodiments, the controller 118 may also include, or otherwise be communicatively connected to, other data storage mechanisms (e.g., one or more hard disk drives, optical storage drives, solid state storage devices, etc.) that reside within the client computing device 110. It should be appreciated that although FIG. 1 depicts only one microprocessor 120, the controller 118 may include multiple microprocessors 120. Similarly, the memory of the controller 118 may include multiple program memories 122 or multiple RAMs 124. Although the FIG. 1 depicts the I/O circuit 126 as a single block, the I/O circuit 126 may include a number of different types of I/O circuits. The controller 118 may implement the program memories 122 or the RAMs 124 as semiconductor memories, magnetically readable memories, or optically readable memories, for example.

In some embodiments, the front-end components 102 may communicate with the back-end components 104 via the network 130. The network 130 may include a proprietary network, a secure public internet, a virtual private network, or any other type of network, such as dedicated access lines, plain ordinary telephone lines, satellite links, cellular data networks, combinations of these, etc. Where the network 130 comprises the Internet, data communications may take place over the network 130 via one or more Internet communication protocols.

The back-end components 104 may include one or more servers 140 communicatively connected to the network 130 by a link 135. Each server 140 may include one or more processors 162 adapted and configured to execute various software applications and components of the system 100, in addition to other software applications. The server 140 may further include a database 146, which may be adapted to store data related to the system 100, such as a database associating images of known objects with labels or information regarding vendors. The server 140 may access data stored in the database 146 upon receiving a request from the client computing device 110. The server 140 may have a controller 150 that is operatively connected to the database 146. It should be noted that, while not shown, additional databases may be linked to the controller 150 in a known manner.

The controller 150 may include a program memory 160, a processor 162, a RAM 164, and an I/O circuit 166, all of which may be interconnected via an address/data bus 165. As with the controller 118, it should be appreciated that although only one microprocessor 162 is shown, the controller 150 may include multiple microprocessors 162. Similarly, the memory of the controller 150 may include multiple RAMs 164 and multiple program memories 160. Although the I/O circuit 166 is shown as a single block, it should be appreciated that the I/O circuit 166 may include a number of different types of I/O circuits. The RAM 164 and program memories 160 may be implemented as semiconductor memories, magnetically readable memories, or optically readable memories, for example. The server 140 may further include a number of software applications or routines stored in a program memory 160. In some embodiments, these applications or routines may form modules when implemented by the processor 162, which modules may implement part or all of the methods described herein. In further embodiments, the various software applications may include a web server application responsible for generating data content to be included in web pages sent from the server 140 to the client computing device 110.

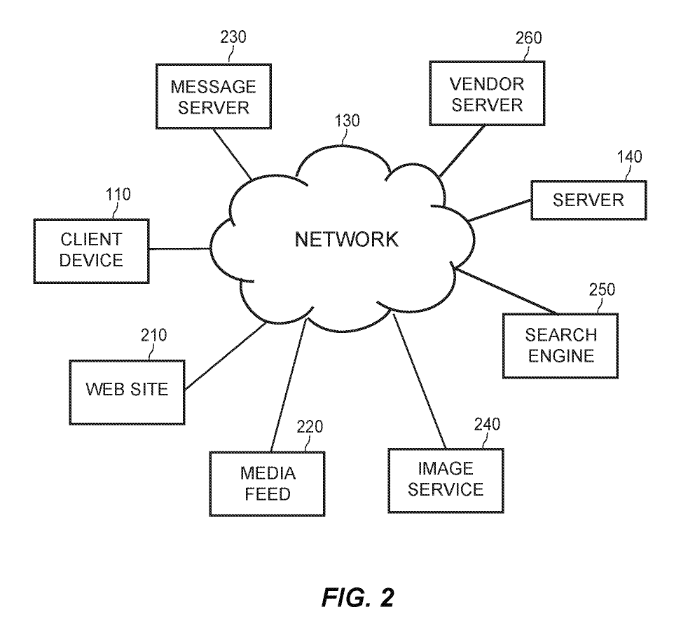

The back-end components 104 may further include one or more data sources 170, communicatively connected to the network 130 via link 175. The data sources 170 may include public or proprietary databases including information that may be associated with objects in images, such as labels identifying objects previously identified within images. For example, a data source 170 may include information for a reverse image search that may be used to identify text labels for an image or portion thereof. The one or more data sources 170 may further include databases or servers associated with vendors, providing information regarding products or services (e.g., vendor web sites). In some embodiments, the data sources 170 may be owned, maintained, or administered by third parties. Additionally, or alternatively, the data sources 170 may include databases maintained by an entity that operates, controls, or administers the server 140. Exemplary data sources 170 are further discussed below in connection with FIG. 2.

A user may launch a client application on the client computing device 110 to communicate with the server 140. Additionally, the customer or the user may also launch or instantiate any other suitable user interface application (e.g., via a web browser). Similarly, the server 140 may implement one or more programs, routines, applications, or modules to communicate with the client computing device 110 or data sources 170, obtain information, process information, or provide information to the client computing device 110. In some embodiments, the server 140 may further execute software programs or applications as a web server. In some embodiments, the client computing device 110 may operate as a thin client device, wherein substantially all of the processes that would be implemented at the client computing device 110 may be executed at or directed by the server 140.

FIG. 2 illustrates a block diagram of an exemplary communication system 200 further illustrating a particular embodiment of the object identification system 100. The exemplary communication system 200 includes the client computing device 110, server 140, and various exemplary data sources 170 communicatively connected via the network 130. The exemplary data sources 170 include input data sources associated with input images (i.e., web sites 210, media feeds 220, and message servers 230), evaluation data sources associated with image processing and searching (i.e., image services 240 and search engines 250), and commerce data sources (i.e., vendor servers 260). These illustrated data sources 170 are presented as examples in order to further illustrate the operation of the object identification system 100. In alternative embodiments, additional, fewer, or alternative data sources 170 may be included or alternatively disposed. For example, one or more of the data sources 170 may be incorporated into or implemented by the server 140 in some embodiments, such as the image service 240 or search engine 250.

The input data sources may provide electronic images including objects to be identified. A user of the client computing device 110 may receive or access images from a web site 210, a media feed 220, or a message server 230. For example, the user may select an image containing an object of interest from a web site 210, such as an image accompanying a news story. Likewise, the user may select an image in a media feed 220, such as a social media site feed associated with the user. Such images may include images shared by an acquaintance, with or without accompanying text. Images may likewise be received from message servers 230, such as e-mail or SMS text message servers. The user may select such an image or portion of such an image to be searched to identify objects and associated products or services. In some embodiments, the server 140 may receive an indication of a location of an image from the client computing device 110, such as a URL of an image on a publicly accessible web site 210. In such instances, the server 140 may similarly access the image via the network 130 based upon the indication of the network location received from the client computing device 110.

The evaluation data sources may provide information associated with images (e.g., image labels or keywords) or may provide information associated with keywords (e.g., products or services related to keywords derived from images). As discussed in further detail below, one or more image services 240 may be used to process an image received by the server 140 from the client computing device 110. The server 140 may be communicatively connected to the one or more image services 240 via the network 130. The server 140 may send the image or a portion thereof to an image service 240 and may receive one or more image labels associated with the image or an object represented within the image from the image service 240. The one or more image services 240 may perform reverse image searching or other content-based image retrieval (CBIR) techniques to identify salient features of images. Such techniques may include applying filters and algorithms to evaluate the image and identify objects represented within the image. For example, a plurality of filters (e.g., Gabor filters) may be applied to the image to identify the salient features of the image (e.g., edges of objects), which may then be further evaluated using algorithms or rules generated by machine learning techniques applied to a dataset of images of known characteristics. The rules may identify tags or labels associated with the image or may identify similar images having known labels. The labels or other metadata associated with the similar images may be then returned as being relevant to the searched image. Some image services 240 may further utilize metadata associated with the image to determine image labels, when available, such as EXIF data. Thus, the image services 240 may provide textual labels associated with objects or other features represented within a searched image, which labels may be further evaluated by the server 140 to determine keywords relevant to products or services associated with an object represented within the image. In some embodiments, the server 140 may likewise send keywords to one or more search engines 250 to obtain information regarding products, services, or vendors. The search engines 250 may be general-purpose search engines or may be customized or restricted-access search engines, such as search engines configured to search a proprietary database of commercial information (e.g., vendor information, product information, or service information). In some embodiments, one or more search engines 250 may be queried to identify vendor servers 260, vendor web sites, vendor media streams, vendor databases or other commercial data sources providing information regarding products or services associated with an object in an image based upon keywords derived from analysis of the image. Commercial data may then be obtained from the identified commercial data sources.

The commercial data sources may provide information regarding particular products or services offered by sellers or service providers. Such commercial data sources may include web sites, databases, or other sources of data associated with vendors. The commercial data sources may include vendor servers 260, such as vendor web servers that host or provide data to vendor web sites. Such vendor servers 260 may provide data regarding products or services offered by corresponding vendors, which may include descriptions or images of products or services. In some embodiments, the vendor servers 260 may further provide pricing and ordering information. As discussed further below, the server 140 may access relevant data regarding products or services from the vendor servers 260, such as by scraping data from a vendor web site. Such commercial data may then be used to present purchase options or other information to users via the client computing device 110.

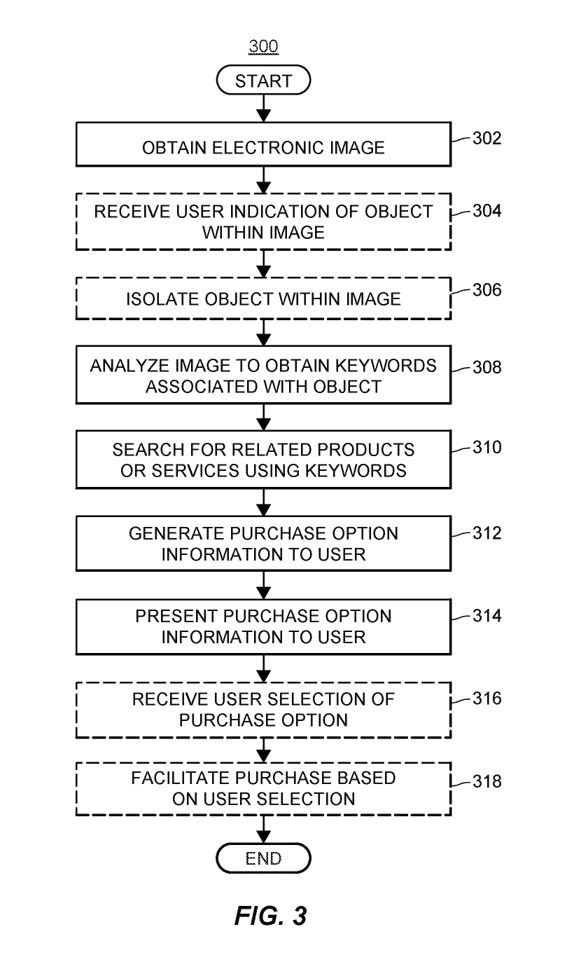

FIG. 3 illustrates a flow diagram of an exemplary object identification and purchase option presentation method 300. The method 300 may be implemented using the components of the object identification system 100 to obtain and process an electronic image in order to identify a product or service and to present options to a user, which may be purchase options for a product or service. The method 300 may begin with obtaining an electronic image to be processed (block 302). Once the image is obtained, in some embodiments, an indication associated with an object within the image may be received from the user (block 304). The object may be isolated within the image (block 306), such as by detecting a context for the object or by cropping out unrelated parts of the image. The image (or a part thereof) may then be analyzed to obtain keywords associated with the object (block 308). Once the keywords are determined, related products or services may be identified by searching databases or retailer sites using the keywords (block 310). From the results of such searching, purchase option data may be generated (block 312) and presented to the user (block 314). In some embodiments, the method 300 may further include receiving a selection of a purchase option from the user (block 316) and facilitating a purchase of the selected product based upon the user selection (block 318). Although certain actions of the method 300 are described herein as being performed by or at the client computing device 110 or the server 140, alternative embodiments may include performing some actions by or at the other device. The method 300 is exemplary only, and additional, alternative, or fewer actions may be included in alternative embodiments.

At block 302, the client computing device 110 may obtain an electronic image to process. The electronic image may be obtained by various means. In some embodiments, the user may take a digital photograph using a camera of the client computing device 110. For example, the user may position the camera to capture an image of an object of interest (e.g., a watch) and control the timing of image capture (e.g., by pressing a physical or virtual button). In some such embodiments, the image may be captured using a special-purpose application operating on the client computing device 110 that is configured to perform part or all of the method 300. Thus, the user may operate the camera from within the special-purpose application to capture the image. In some embodiments, the special-purpose application may cause the client computing device 110 to automatically capture a series of images in order to obtain multiple views of the object. Similarly, the special-purpose application may control the client computing device 110 to adjust the focal length of the camera 115 or to apply one or more filters to the images to vary the image parameters, thereby capturing multiple types of views of the object. Obtaining multiple views or types of views of the object can improve the accuracy of keyword generation by enabling separate analysis of multiple images of the same object and, in some embodiments, comparison of the labels associated with the various images to determine the most salient keywords.

In further embodiments, the electronic image may be obtained by retrieving an image file from the program memory 122 of the client device based upon a user selection. Such retrieved electronic image may be an image previously captured or stored by the user. For example, the user may select an option to retrieve and analyze a stored image within a special-purpose application. In yet further embodiments, the electronic image may be obtained from a third party via the network 130 (e.g., a data source 170, such as a web site 210, a media feed 220, or a message server 230). Such third party source may include data provided through an application on the client computing device 110, including web site data accessed through a web browser application. In some such embodiments, the user may select the image from within a web browser or other application operating on the client computing device 110 using an add-on component installed to operate within and augment the operation of such application. The image may include a still image or a part of a video (such as one frame). To select the electronic image, the user may click, tap, or hover over the image to indicate the image to be processed. In some embodiments, the user may virtually drag the image from one location on the display 112 to another location to select the image for analysis. For example, the user may tap and drag an image displayed within a web browser to an indicator of a special-purpose application (e.g., an icon associated therewith) to obtain the image for processing. As another example, the user may right-click (or long press) on the image while a special-purpose application is running to access an option to select the image for processing.

At block 304, in some embodiments, the client computing device 110 may receive a user indication of a location within the image associated with an object of interest within the image. If no user indication is received, the method 300 may continue by identifying one or more objects within the electronic image and providing information regarding each of the identified objects. By indicating a location of particular interest within the electronic image, however, the user may improve the results of the analysis. For example, the user may be interested in only one or a few objects within an image showing a number of objects, such as a particular shirt within an image showing multiple people each wearing different types of clothing. As another example, the user may be interested only in one type of product from among a plurality of products on a shelf. The user indication may include an identification of one or more points within the image, which may be indicated by a user clicking or tapping within the image. Additionally or alternative, the user indication may include a selection of an area, such as by a user circling an area or cropping the image to focus on an area. For example, the user may create a rectangular user indication of an area of particular interest within the image by clicking or tapping on a first point, then dragging a pointer to a second point before releasing a mouse button or withdrawing a finger or stylus from a touchscreen display 112.

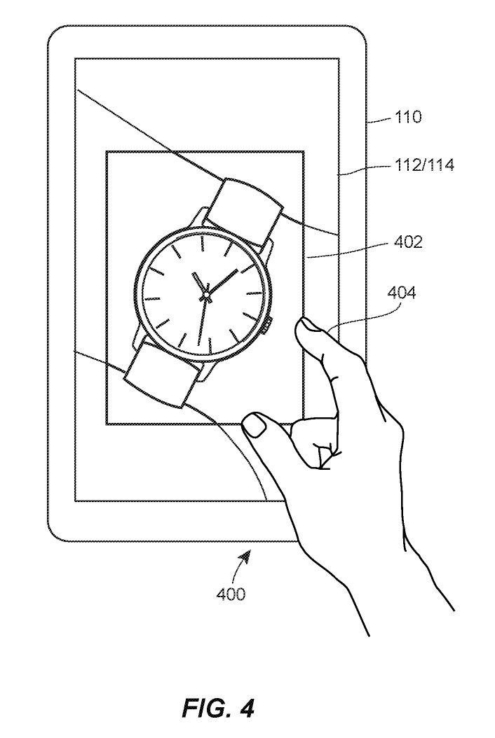

FIG. 4 depicts an exemplary user selection of a location associated with an object within an electronic image 400. The electronic image 400 is presented to the user via a client computing device 110 using a touchscreen display 112/114 that combines the display 112 and input 114. As illustrated, the user indication 402 is a rectangular area within the electronic image 400 that shows a watch face as an object of interest to the user. The user moves a finger 404 along the surface of the touchscreen display 112/114 to select a rectangle within the electronic image 400 as the user indication 402. This action crops the previously captured image to an area defined by the user indication 402, which includes the watch face. Other portions of the original electronic image 400 may be discarded or ignored for purposes of further processing, or the other portions may simply be used for background context or scale. The user indication 402 thus allows the following analysis to focus on the watch face, rather than other parts of the electronic image 400.

Returning to FIG. 3, the method 300 may continue at block 306, where the client computing device 110 may isolate an object within the electronic image. In some embodiments, the object isolation and/or further analysis may be partially or wholly performed by the server 140 based upon data received from the client computing device 110 via the network 130. For example, the client computing device 110 may send the electronic image or an indication of a location of the image to the server 140 for analysis. This may be useful, as the server 140 will typically have greater processing power and memory than the client computing device 110. If the user has indicated a location of an object of interest, the indication may be sent to the server 140, or a sub-image based upon the user indication may be sent to the server 140. Thus, the object may be isolated by extracting one or more temporary sub-images including the indicated location. For example, a new image containing only the area of the user indication 402 may be generated in the example of FIG. 4. As an alternative example, one or more areas within the electronic image centered around a point indicated by the user may be used to generate isolated sub-images for further analysis.

In some embodiments in which no user indication of a location of particular interest has been received, isolating an object within the image may include dividing the image into a plurality of regions, which may include one or more partitions of the image. Such regions may be separately analyzed to identify relevant features, such as objects within the regions. In this manner, a plurality of distinct objects within the electronic image may be identified by isolating the objects in various regions. In further embodiments, isolating an object may include identifying one or more context features within the image. Such context features may include faces, ground, sky, walls, or other background features within the image that may be used to determine an orientation or scale of the image. For example, a face may be identified within the image and assumed to be of an average size, from which the size of objects within the image may be approximated based upon relative size of the object compared to the size of the face within the image. As another example, a background may be identified and separate from a foreground or object, such as by identifying a sky, wall, or objects out of focus. Similarly, an orientation of the image may be determined based upon contextual features, such as a doorframe or horizon.

At block 308, the server 140 may analyze the image (or portions thereof) to obtain keywords associated with the object. Analysis may include performing a reverse image search on all or part of the image to obtain image object labels that describe one or more objects within the searched image. Additional labels associated with other aspects or features of the image may also be obtained, along with the image object labels. These additional labels may be useful for context, or they may simply be extraneous data to be identified and removed. For example, labels associated with background features such as LAKE, SKY, or TREE may be removed to obtain the image object labels. The image object labels may be used as keywords, or keywords may be derived from the image object labels. The image object labels may identify a type of an object, a manufacturer or maker of the object, a particular model of the object, and/or other characteristics of the object (e.g., color, style, etc.). Reverse image searching may compare an image against characteristics of many previously evaluated images to determine labels indicative of the image contents, which labels may be text describing aspects of the image or items represented within the image. In some embodiments, a plurality of images (i.e., sub-images of or regions within the electronic image) may be analyzed using reverse image searching to generate a plurality of lists of image object labels. The plurality of lists of image object labels may then be compared to identify the most salient labels or to remove outlier labels. In some embodiments, the image object labels may be selected from one or more lists of labels generated by reverse image searching, such that the image object labels are associated with objects likely to be of interest to the user.

The server 140 may perform the image analysis or may send the image (or portions thereof) to one or more image services 240 for analysis. Thus, reverse image searching may involve accessing or searching a third-party database (such as data source 170) or using a third-party searching tool (such as image service 240). Additionally, or alternatively, reverse image searching may be performed using a proprietary data source (such as database 146) or algorithms by the server 140. In some embodiments, each image may be analyzed by a plurality of algorithms associated with a plurality of image services 240 to evaluate different aspects of the image. For example, separate image services 240 may be used to analyze the image with respect to identifying locations or landmarks, text within the image, object types, faces within the image, or logos within the image. For example, the image or an area of the image associated with an object may be further searched for logos or text represented within the image. If logos or text are found, additional keywords associated with the logos or text may be added to the image object labels. In some embodiments, particularly embodiments in which multiple objects are identified, such additional keywords relating to text or logos may be associated with the keywords relating to objects in proximity to the logos or text within the image (i.e., within the same area of the image).

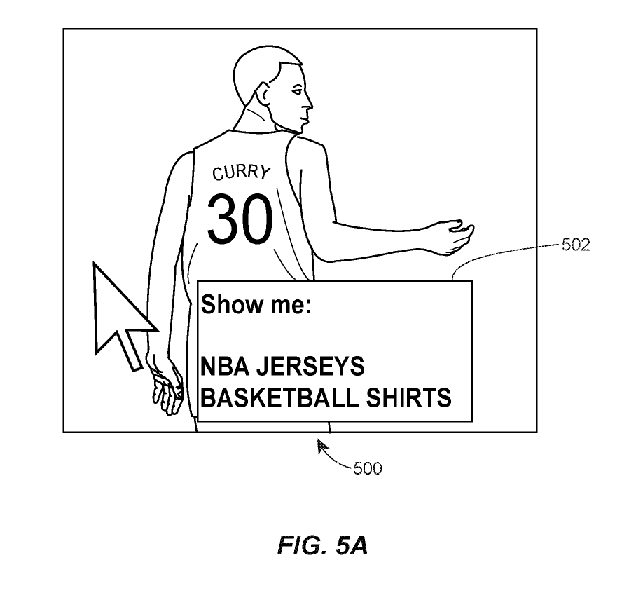

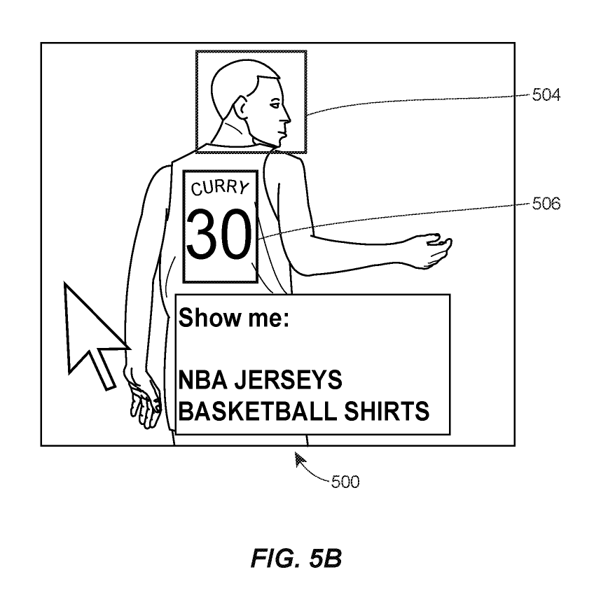

The keywords obtained by analysis of the image may be returned to the client computing device 110 or may be used by the server 140 to further search for related products or services. If the keywords are returned to the client computing device 110, some or all of the keywords may be presented to the user to select from alternative categories of products or to select between a plurality of objects identified within the image. FIG. 5A illustrates an exemplary embodiment of such presentation of options relating to alternative keywords in a search option text box 502 overlaid on an electronic image 500. As illustrated, the search option text box 502 including alternative keyword phrases “NBA JERSEYS” and “BASKETBALL SHIRTS” that could be selected by the user to search for products similar to an object (i.e., a basketball jersey) within the electronic image 500. The difference between related keyword phrases may ultimately lead to at least partially distinct purchase options in some instances, so the user selection may improve the accuracy of the resulting purchase options. For this reason, in some embodiments, alternative keyword phrases may be presented to the user upon request by the user when a previous search failed to produce purchase options desired by the user. Upon user selection of one of the keyword phrases, the selected keyword phrase may be used to search for products or services similar to the object, as described further below. FIG. 5B illustrates the same electronic image 500, further illustrating additional features of the image analysis. As discussed above, context features (such as faces) may be identified in electronic images. A context feature 504 (a face) is illustrated surrounded by a rectangle in order to show the operation of the method. Similarly, an object text 506 (a name and number) is illustrated surrounded by a rectangle. The context feature 504 may be used to estimate an approximate size of the object, which may be used to identify or confirm the identification of the object as a basketball jersey. The object text 506 may likewise be used to confirm that the object is a basketball jersey, as well as providing addition information about the team and player associated with the object in order to generate better information for subsequence searching. Although the keyword phrases illustrated in FIGS. 5A-5B are related, other embodiments may present alternative keyword phrases associated with distinct objects within an image. For example, one keyword phrase may be associated with a shirt, while another keyword phrase may be associated with a basketball.

Turning again to FIG. 3, at block 310, the server 140 may search for related products or services similar to or associated with the identified object based upon the keywords. The similar products may be items for sale that are generally of similar types as the identified object (e.g., shirts, jerseys, licensed jerseys for a team). Alternatively, in some embodiments, the similar products may be limited to products that are identical to the identified object (e.g., a home jersey for a particular player on a particular team). When a related service is identified, such service may be determined as a service related to the object (e.g., vehicle maintenance, clothing tailoring, or lawn care services) or based upon a context associated with the object (e.g., upcoming performances or events associated with a celebrity, venue, or team). In some embodiments, a plurality of online vendor sites (e.g., vendor servers 260) may be searched to identify similar products, or an online marketplace (e.g., search engine 250) may be searched to identify similar products. In further embodiments, a custom data table or list of sellers may be used to search for similar products or services. In yet further embodiments, results from the search may be stored in a custom data table or list in the database 146 for presentation of information to the user. By generating a custom data table from the search results, purchase options corresponding to results from a plurality of vendors may be seamlessly combined for presentation to the user.

At block 312, the server 140 may generate purchase option data or other similar option data from the search results. The purchase option data may include information regarding availability and price, as well as information regarding the characteristics of the products or services identified in the search results. The purchase option data may include offers by one or more sellers to sell products similar or identical to the identified object within the electronic image. Depending upon user preferences, the purchase option data may include products generally similar to the identified object in the electronic image or may include only information regarding products identical to the identified object within the electronic image. Additionally, or alternatively, the purchase option data may include information regarding services associated with the object. In some embodiments, the purchase option data may be filtered based upon user preferences, user selection of product or service searching, product or service price, vendor characteristics (e.g., location, shipping options, reliability or rating, etc.), or vendor status (e.g., preferred sellers or preferred service providers). In further embodiments, the purchase option data may include a ranking or ordering of the purchase options (e.g., a ranking based upon price, location, or quality). Once generated, the server 140 may send the purchase option data to the client computing device 110 via the network 130.

At block 314, the client computing device 110 may receive the purchase option data and present related purchase option information to the user. The purchase option information may be presented to the user as a list of purchase options for products or services. In some embodiments, a map showing locations of vendors associated with the purchase options may be presented to the user. The purchase option information may be an indication of the purchase option data, or it may be generated by the client computing device 110 based upon the purchase option data. For example, the purchase option data may include web site addresses or other resource locators, which the client computing device 110 may access in order to obtain additional information regarding each of one or more purchase options (e.g., product previews, images, or prices). The client computing device 110 may further reorder the results indicated by the purchase option data based upon user preferences, product similarity, service relevance, vendor priority, or other factors. In some embodiments, only purchase options from one or more preferred vendors may be presented. Similarly, in some instances, user preferences or selections may be used to limit the purchase options presented to the user either to product or to services, while not displaying purchase options associated with the other category (services or products, respectively). Regardless of the presentation, the purchase option information presented to the user may facilitate user purchases of products or services using the client computing device 110. This facilitation may include providing links to one or more electronic commerce sites where each product associated with each purchase option may be bought. Such links may be links to vendor websites related to the products or services.

At block 316, in some embodiments, the client computing device 110 may further receive a user selection of a purchase option from a list of purchase options presented to the user. For example, the user may indicate a selection of one of the purchase options by selecting (e.g., clicking or tapping) an area of the display 112 presenting purchase option information associated with the purchase option. Once the user selection of a purchase option is received, the client computing device 110 may facilitate the purchase at block 318. Facilitating the purchase may include directing the user to a vendor web site associated with the selected product or service, from which the user may proceed to purchase the product or service directly from the seller. Alternatively, facilitating the purchase may include providing additional information and/or confirming a purchase decision, then process an order by coordinating payment and other aspects of the transaction (e.g., shipping of the product or scheduling of the service). In some embodiments, additional order options associated with the purchase may be presented to the user, and additional data needed for the purchase may be obtained. Such additional order options may depend upon and may be determined based upon a genre of the product or service. For example, clothing size or color options, delivery or installation options, or service scheduling options may be presented to the user. User responses may be received from the client computing device 110 and used by the server 140 to facilitate the purchase. The method 300 may then terminate.

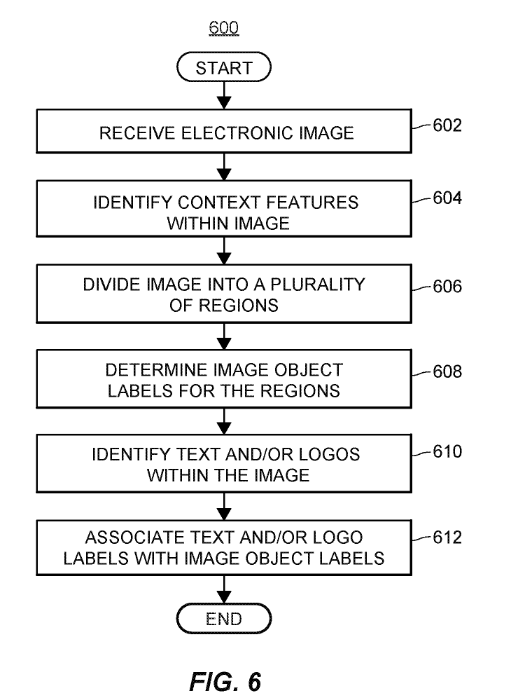

FIG. 6 illustrates a flow diagram of an exemplary object identification method 600 that may be performed in conjunction with or as an alternative to part of the method 300 described above. In some embodiments, the method 600 may be performed by the server 140 in response to a communication from the client computing device 110 that includes an image to be processed. Thus, the method 600 may begin by receiving an electronic image (block 602). Upon receipt of the electronic image, the image may be processed to identify context features within the image (block 604). To obtain keywords associated with one or more objects within the image (as discussed above), the image may be further processed by: dividing the image into a plurality of regions (block 606), determining image object labels by analysis of the regions (block 608), identifying text or logos within the image (block 610), and associating labels for the identified text or logos with the image object labels to generate the keywords for the image (block 612). The method 600 is exemplary only, and additional, alternative, or fewer actions may be included in alternative embodiments. Although the method 600 is described as being implemented by the server 140, alternative embodiments may be implemented in whole or in part by the client computing device 110.

At block 602, the server 140 may receive one or more electronic images from the client computing device 110. In some embodiments, the client computing device 110 may communicate information indicating a virtual location of an image, such as a URL address. In such embodiments, the server 140 may obtain the electronic image from such location.

At block 604, the server 140 may identify one or more context features within the image. As noted above, such context features may include faces, ground, sky, walls, location, landmark, or other background features within the image that may be used to determine an orientation or scale of the image. Such context features may be identified by the server 140 or by an image service 240 by applying a plurality of filters to the image and comparing the results against known patterns associated with context features. Such known patterns may be identified in advance through known machine-learning techniques by analysis of many images having known context features.

At block 606, the server 140 may divide the image into a plurality of regions. If context features have been identified, the number or size of the plurality of regions may be determined based upon such context features. For example, more and smaller regions may be used if the context features indicate that the image was taken from a distance than if the context features indicate the image was taken close up to an object. The regions may be uniform or variable, overlapping or non-overlapping, and of any convenient shape. In some embodiments, a plurality of overlapping regions of varying sizes may be used to better isolate objects represented within the image. For example, a plurality of grids each having different numbers of non-overlapping rectangular sections may be used to divide the image into a plurality of regions for analysis, such that each grid completely covers the image and completely overlaps with each other grid. In some embodiments, one or more regions may include rotations or translations of parts of the image in order to obtain better analysis results.

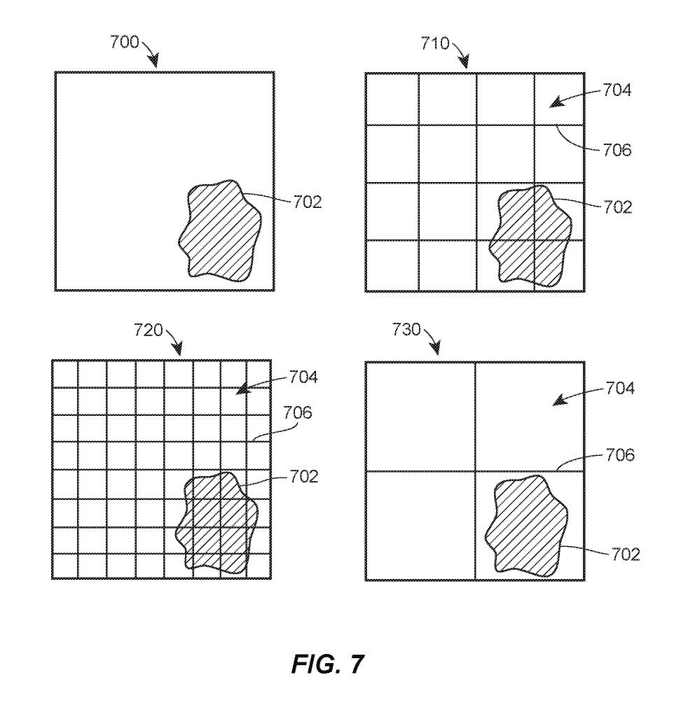

FIG. 7 illustrates an exemplary plurality of grids with varying sizes of non-overlapping rectangular sections. To better illustrate the use of such grids, an exemplary representation of an image 700 containing an object 702 is shown. Exemplary grids 710 and 720 are illustrated as overlaid upon the image 700. Grid 710 illustrates an exemplary four-by-four grid partitioning the image into sixteen rectangular sections 704. The edges 706 of the sections 704 are shown as lines for ease of illustration, but it should be understood that such edges would not necessarily be visible in operation. Grid 720 illustrates an alternative exemplary eight-by-eight grid partitioning the image into sixty-four rectangular sections 704, again showing edges 706. As shown, parts of the object 702 are within various sections 704 in both grids 710 and 720. Yet another exemplary grid 730 is illustrated as a two-by-two grid partitioning the image into four rectangular sections 704, with edges 706 illustrated. Unlike grids 710 and 720, grid 730 contains a section 704 large enough to encompass the entire object 702. Depending upon the object type and the image detail, analysis of the full object 702 or portions of the object 702 may produce better results. Thus, each section 704 in each of the grids 710, 720, and 730 may be separately analyzed, as described elsewhere herein. The results of the separate analyses may be combined or compared to identify the most relevant keywords for objects within the image, as discussed elsewhere herein. For example, analysis of the object 702 in a section 704 of the grid 730 may identify the object as a shoe, while analysis of part of the object 702 in a section 704 of the grid 720 may identify broguing on the shoe. In some embodiments, the keywords may be selected by weighting image object labels generated for the each of the various sections 704 of the various grids 710, 720, and 730 based upon the frequency with which the labels appear in results of analysis of the sections 704. In this manner, salient keywords may be identified for an image showing more than one object or in which the object 702 occupies only a small portion of the image.

Returning to FIG. 6, at block 608, the server 140 may separately analyze each of the plurality of regions to determine image object labels, as discussed elsewhere herein. In some embodiments, this may include performing a reverse image search for each region, using either or both the server 140 or an image service 240. By separately analyzing each region, the quality of the obtained image object labels may be improved by reducing the portion of the image analyzed, thereby allowing at least some regions to focus on an object of interest (or a portion thereof), without extraneous features of the image or other objects. As above, the image object labels may be used as keywords, or keywords may be derived from the image object labels. The keywords or image object labels may indicate objects identified within the regions, aspects of the objects, or contexts associated with the objects.

At block 610, the server 140 may identify text, logos, or other similar features within the image. In some embodiments, this may include analyzing the full image. Additionally, or alternatively, the regions may be separately analyzed to detect logos or text. In some embodiments, a set of logos potentially associated with objects identified within the image (as indicated by the image object labels) may be searched based upon the determined image object labels. For example, the image may be searched for team logos if the image object labels indicate a jersey in the image. Text within the image may be identified using optical character recognition (OCR) techniques. In some embodiments, regions of the image may be analyzed to recognize text on a representation of an identified object within the electronic image. Such text may be of greater relevance to the object than text elsewhere in the image, such as text incidentally in the image background.

At block 612, the server 140 may determine and associate text or logo labels with the image object labels. Labels for logos may be determined by looking up labels for the logos in a database 146 or other data source 170. Labels for text may be generated based upon the detected text itself, which may be compared against databases of known words to select the most likely text in some embodiments. In some embodiments, this may include searching the observed text extracted from the image via a search engine 250 in order to determine the most likely label. Such method is of particular value where text within the image is only partially visible or discernible using the OCR techniques. In further embodiments, additional labels or context data may be used to provide context for the text search using the search engine 250, thereby obtaining better search results. Once determined, the text or logo labels may be associated with some or all of the image object labels. The labels may be associated based upon the regions in which the text or logo appear, or may be associated based upon proximity of the text or logo to a location of a representation of an object within the image. The combined labels may then be used as keywords for further searching, or keywords may be derived from the labels. Such keywords may be used for further searching and purchase option presentation, as discussed elsewhere herein.

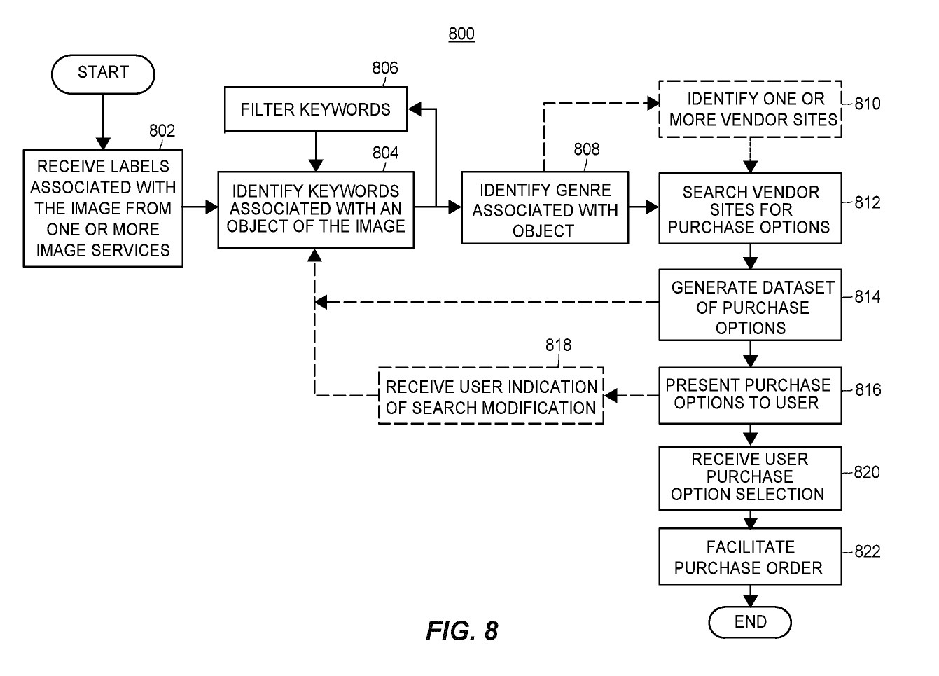

FIG. 8 illustrates a flow diagram of an exemplary purchase option generation method 800 for automatically generating lists of purchase options using labels associated with images selected by users. The method 800 may be implemented using the components of the object identification system 100 to obtain and process an electronic image in order to identify and present relevant product or service purchase options to a user, which may be implemented in conjunction with any of the other methods discussed herein. By identifying particularly salient keywords based upon objects in images selected by users, the method 800 improves search accuracy and enables the server 140 to automatically identify and present more relevant product and service purchase options to the user. Thus, a user of a mobile computing device 110 may send an indication of an image (or portion thereof) to a server 140, and the server 140 may analyze the image to determine associated labels or may transmit part or all of the image to one or more image services 240 for label determination. In some embodiments, the actions performed at the blocks of method 800 may be implemented as a plurality of software modules or routines running on the server 140. The method 800 is exemplary only, and additional, alternative, or fewer actions may be included in alternative embodiments.

The method 800 may begin with the receipt of a plurality of labels associated with an image (block 802), which labels may be received from one or more image services 240. Keywords associated with an object represented within the image may be identified from the received labels (block 804). The keywords may be analyzed and filtered (block 806) to obtain a set of salient keywords of particular relevance to product or service purchase option identification. Such analysis and filtering may be an iterative process in some embodiments. Once the salient keywords have been identified (block 804), some embodiments of the method 800 may include identifying a genre (e.g., shirt, pants, shoes, car, electronics, or sporting goods) associated with the object based upon the identified keywords (block 808). In further embodiments, the method 800 may include identifying vendor sites to search (block 810), which may be selected based upon keywords or genres associated with the objects. Regardless, the method 800 proceeds to search one or more vendor sites for information relating to purchase options based upon the keywords (block 812). Relevant information may be scraped from the vendor sites and used to generate a dataset of purchase options containing purchase option data (block 814). If the purchase option data is insufficient, adjustments may be made to the keywords by identifying more, fewer, or alternative keywords (block 804). If the purchase option data is sufficient, the purchase options may be presented to a user to enable user selection and purchase of products or services (block 816). When the user selects a purchase option (block 820), a purchase order may be generated or otherwise facilitated (block 822). In some embodiments, an option to modify the search parameters may be presented to the user, along with the purchase options. If the user elects to modify a search parameter (block 818), the keywords may be adjusted accordingly (block 804). Whenever the keywords are adjusted, a new search of vendor sites may be performed to obtain new purchase option data (and to present the user with a corresponding set of purchase options associated therewith).

At block 802, the server 140 may receive a plurality of labels associated with an image. The plurality of labels may be received from one or more image services 240 via network 130 in response to one or more requests for such labels sent to the image services 240 from the server 140. Such request may include an image to be analyzed by the image service 240. The image may be an electronic image received by the server 140 from a user of a mobile computing device 110 via network 130. In some embodiments, the image may be a part of an electronic image received from the user, such as a region of the image selected by the user or divided from the image by the server 140 using a grid or similar techniques, as discussed above. In some embodiments, the server 140 may receive or generate a plurality of subdivided images from an original image indicated by the user, such as by partitioning the image into sections as discussed above. Each of the plurality of subdivided images (or a subset of relevant subdivided images) may be sent to the image services 240 for evaluation. Alternatively, in some embodiments, the image services 240 may perform such subdivision. In any case, the one or more image services 240 may receive the image from the server 140 and process the image to determine labels associated with the received image. The labels may then be sent to the server 140 for further use. In alternative embodiments, the server 140 may perform the analysis of some or all of the image services 240, such as recognizing text within the image using OCR techniques.

In some embodiments, the server 140 may store previously identified labels in the database 146 for future use when an identical image is again indicated by the same or a different user. In such embodiments, the server 140 may calculate a checksum value for each image using an appropriate algorithm, which checksum may be stored with the set of labels associated with the image in the database 146. When an image is obtained upon a user search request, the server 140 may first calculate the checksum of the image using the same algorithm. The newly calculated checksum may then be compared against checksums stored in the database 146 to identify identical images previously analyzed. If an identical image is identified by comparison of checksums, the server 140 may access the associated labels in the database 146, which may be used instead of newly identified labels from the image services 240. Such embodiments may be used to reduce the delay caused by communication with and processing of the image by the image services 240. In further embodiments, keywords identified with an image (as described further below) may similarly be stored in the database 146 and used for later-received identical images, based upon checksum comparison.

As an example, the server 140 may divide a portion of an image received from a client computing device 110 into a plurality of subdivided images corresponding to a user selection of an area within the original image. The server 140 may then send a set of the subdivided images (which may include the full portion of the image or the full image) to a plurality of image services 240 for evaluation. The image services 240 may include one or more of the following: an object type recognition service, a text recognition (OCR) service, a landmark or location identification service, a facial recognition service, a logo recognition service, or other similar service. Each such image service 240 may be configured to perform automated analysis of received images to identify features of the images. Such feature identification may include image categorization according to a hierarchical classification system or probabilistic image matching with a database of other known images, which may include the application of machine learning techniques to evaluate the images. From such analysis, the image service 240 may further identify and return labels associated with the images, such labels being text descriptions of aspects of the images or text extracted from the images. Descriptive labels may include image object labels describing types of objects within the image, which may be identified by automated comparison against other similar images as text previously associated with the other similar images. Such descriptive labels may include labels indicating specific identification of unique objects, such as people or landmarks, as well as contextual labels associated with such unique objects. Descriptive labels may also include general contextual labels, such as labels associated with backgrounds or common conditions, such as sky, water, fields, mountains, sun, moon, clouds, stadium seating, crowds, roads, highways, or other frequently occurring identifiable elements of images. Descriptive labels may likewise include logo labels identifying brands, groups, or other identifying marks (e.g., trademarks or service marks) associated with objects within the images. Extracted labels may include text extracted from an image using OCR or related techniques. Such text may include complete or partial words, which may include errors that may be corrected by the image service 240 or by the server 140. Other types of labels may be generated by image services 240 in further embodiments.

At block 804, the server 140 may identify keywords from the received labels, which keywords may be associated with an object within the image. Identifying keywords may include aggregating labels received from a plurality of image services 240, as well as aggregating labels generated for each of a plurality of subdivided images to obtain a combined set of labels associated with the original image. The combined set of labels may be used as an initial set of keywords, or the server 140 may search for additional keywords based upon the combined set of labels and, in some embodiments, based upon the labels received from particular image services 240 or associated with particular subdivided images. For example, the server 140 may attempt to complete or correct extracted text labels that contain partial text or errors. This may be achieved by searching a database of known words or by searching for matching words or phrases, such as via a search engine 250. In some embodiments, OCR text labels may always be verified by such searching in order to improve the quality of the keywords. Thus, the initial set of keywords may be identified or derived from the labels associated with the image (or images). Such initial set of keywords is likely to contain an excessive number of terms, however, which will reduce the quality of purchase option searches using such keywords as search terms. To remedy this problem and improve the quality of automated image-based searching, the keywords may be filtered by the server 140. In some embodiments, such filtering may be performed in an iterative manner until the set of identified keywords meets certain keyword criteria. As discussed below, the keywords may be filtered and divided into a plurality of subsets of keywords for further use in searching vendor sites.

At block 806, the server 140 may filter the keywords to obtain more useful keywords for purchase option searching. Keyword filtering may include the application of rules or algorithms identified by machine learning techniques to remove low-quality search terms or to identify high-quality search terms. Such rules or algorithms may be generated by training the machine learning algorithms using the results of previous implementations of the method 800. In some embodiments, such filtering may include identifying and removing redundant keywords, which may be exact matches or related terms (e.g., synonyms or functional equivalents). In further embodiments, information regarding the frequency with which the keywords occur in the set may be used to select between alternative versions or may be retained for further use in performing purchase option searching or in ranking search results. Keywords may be filtered to obtain an efficient number of keywords for improved searching, as well as to remove keywords that may have low relevance or that may even reduce the accuracy of the search. By such filtering or related keyword analysis, the method 800 generates a highly salient set of keywords that can target purchase options associated with objects of particular interest within an image. Thus, the process avoids the problem of excessive breadth in searching based upon the labels received from the image services 240.

Filtering the keywords may include identifying a limited set of salient keywords. Such limited set may be selected form the identified keywords to contain a number of keywords within a fixed range. For example, searches with only one keyword typically lack sufficient focus, whereas searches with more than ten keywords also typically lack sufficient focus. Therefore, in preferred embodiments, the limited set of salient keywords includes two to ten keywords. Searches may include up to twenty keywords in some embodiments, but such searches typically become less effective as the number of keywords increases beyond ten. Because filtering may nonetheless result in a set of keywords exceeding the maximum number of the fixed range, some embodiments may include identifying a plurality of subsets of keywords, with each subset of keywords being limited to no more than the fixed maximum number of keywords. Some keywords may appears in multiple subsets, such as core keywords occurring with high frequency in the image labels (particularly image object labels descriptive of object types). Other keywords may appear only in one subset, while other initially identified keywords or labels may not be included in any subset. The subsets of keywords may be searched in an iterative manner to generate datasets of purchase options or other options, as discussed below. Such datasets may be compared to determine the most salient keywords or the most effective subsets of keywords, which may be used to develop further rules or algorithms for future filtering using the method 800. For example, subsets of keywords containing mostly contextual keywords or irrelevant keywords may be identified, and such keywords may be recognized as having lower salience to objects in future searches. The efficacy of each subset may be determined based upon the number of results, the frequency of user selection of results, or the proportion of results for the subset that appear as search results for other subsets.

In some embodiments, frequently occurring context labels may be removed from the keywords to avoid directing the search to contextual aspects of the image, rather than objects within the image (e.g., DAY, NIGHT, or SNOW). Such context labels may be relevant to the image searched but may not be relevant to purchase option identification. In some embodiments, however, context may be relevant and may be retained (e.g., when searching for context specific services like snow removal or lawn care services). In further embodiments, context labels may be used to determine a context of the image, which may further be used in the selection or identification of other keywords. For example, context labels in the keywords (or a subset of less-frequently occurring or less-generic context labels) may be searched via the search engine 250 to obtain results, which may be compared against other keywords or may be used to add new keywords. By performing such searches, the context labels may be used to identify the most salient keywords associated with objects of interest in the image, particularly where image object labels are also included in the search. For example, the number of search results for combinations of keywords may be used to identify which keywords are correlated. Such correlations may then be used to determine which keywords may be redundant or may be more or less salient to purchase option searching.

In further embodiments, filtering the keywords may include verifying or filtering text extracted from the image. Because OCR techniques are imperfect and because text within images may or may not be related to objects of interest, the server 140 may apply various evaluation and filtering techniques to obtain salient keywords. Thus, the server 140 may identify extracted keywords that do not match known words, which may indicate partial word extraction or extraction errors. The server 140 may attempt to determine the proper word or may remove such words from the keywords. In some embodiments, the server 140 may search part or all of the extracted keyword strings or phrases via the search engine 250 to identify likely replacements for incomplete or erroneous keywords. Such approach has the advantage of identifying keyword extraction errors that result in alternative legitimate words that can be identified as erroneous in context. Additionally, or alternatively, the length of extracted text may be evaluated to filter the keywords. Lengthy text labels are infrequently relevant to purchase option searches for products or services. Therefore, the length of extracted text keywords may also be limited. In preferred embodiments, the total length of extracted keywords may be limited to no more than twenty characters. Alternatively, each related phrase of extracted text may be limited to no more than twenty characters. In some embodiments, more characters may be allowed, but accuracy of the resulting searches typically deteriorates beyond twenty characters. Thus, if more than twenty characters of extracted text keywords are received, the server 140 may filter such extracted keywords to remove duplicates, eliminate connecting words and articles, removing low-relevance terms using machine learning algorithms, removing text keywords appearing at a further distance in the image from an object of interest, or using other similar techniques.

By these and similar techniques, the server 140 may filter the keywords to generate one or more sets of salient keywords. Such filtering processes may be performed iteratively until at least one sufficiently refined set of keywords is identified at block 804. The sufficiency of the keywords may be determined based upon metrics such as keyword number or total characters, or the sufficiency of the keywords may be determined based upon search results. Thus, the iterative approach may include iteratively implementing blocks 804-814 to identify sets of keywords and perform searches for the identified sets of keywords until sufficient results are obtained. As discussed above, a plurality of subsets of keywords may thus be iteratively searched and the results analyzed to determine the results to be presented to the user.

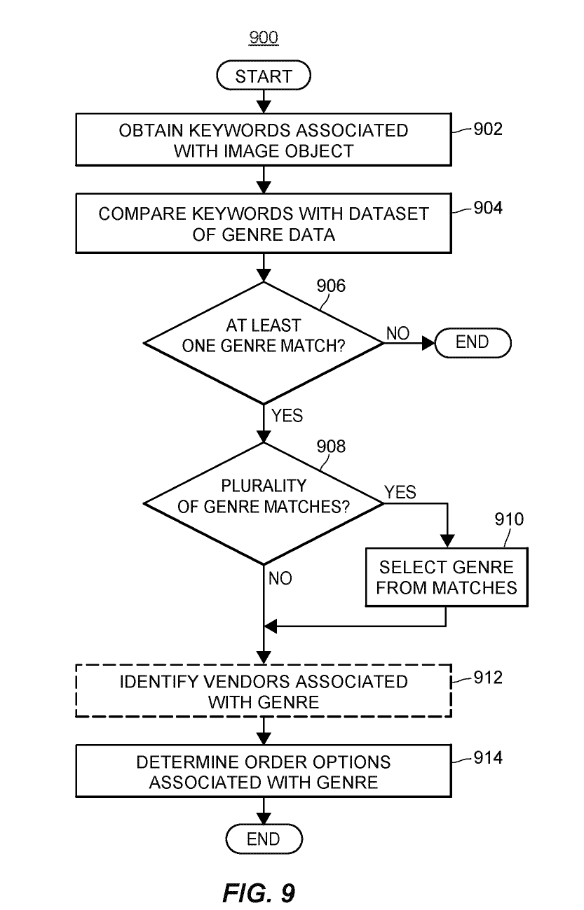

When a set of keywords is identified, the method 800 continues with analysis or searching based upon the keywords. At block 808, in some embodiments, the server 140 may identify a genre associated with the object of interest based upon the keywords. Such genres may be identified either once based upon the initial keywords or may be identified for each set of keywords to be searched. The genres may identify a type of product or service associated with the object of interest in the image, based upon the keywords. For example, a set of keywords including COLLAR and SLEEVE may be identified as associated with a genre corresponding to shirts. In some embodiments, genres may be used to determine whether to search for products or services. For example, a genre identified based upon the keywords may be indicated as being associated with either product or services or with both products and services. The server 140 may identify purchase options associated with the appropriate category (i.e., products, services or both) based upon an indication of the genre. Genres may be used to refine the searches performed, the results presented to the user, or the order options presented to the user, as discussed further below with reference to FIG. 9.

At block 810, in some embodiments, the server 140 may identify one or more vendor sites to search. The vendor sites may include vendor web sites, databases, or other electronic means of presenting information to customers. The vendor sites may be identified with or may be associated with vendor servers 260. In some embodiments, the vendor sites may be identified based upon a genre. For example, a genre corresponding to sporting equipment may be associated with a retailer of such products. Alternatively, the vendor sites may be identified based upon the keywords. For example, the server 140 may search for vendor sites based upon the keywords, prior to searching within vendor sites for products or services associated with the keywords. Alternatively, the server 140 may directly search a fixed list of vendors for all queries. As another alternative, the server 140 may search an electronic marketplace based upon the keywords. As yet another alternative, the server 140 may search within vendor sites without directly identifying such vendor sites by using a search engine 250. Regardless of whether vendor sites are specifically identified, the server 140 may proceed to search for data relating to products or services within the vendor sites based upon the keywords.

At block 812, the server 140 may search the one or more vendor sites for purchase option data based upon the set (or subset) of keywords. Such search may be performed via a search engine 250, which may be a general search engine or a site-specific search engine, or the search may be performed by directly accessing and evaluating the site contents at the server 140. In some embodiments, the server 140 may scrape data from the vendor site by accessing and processing data from the site. The server 140 may fetch data from each target vendor site and attempt to locate any portions of the data related to the keywords or useful for facilitating purchase orders. This may include obtaining images of products, purchase price information, availability information, or order options (e.g., size, color, or features). The information scraped from the vendor site may also be determined by the server 140 based upon the identified genre in some embodiments. In addition to visible (i.e., displayed) text of the vendor site, the server 140 may obtain and analyze metadata (e.g., EXIF data of image files), comments, or other text not typically displayed to a visitor of the vendor site. In further embodiments, the server 140 may perform OCR techniques to images on the vendor site to extract data therefrom. By extracting text from images, the server 140 may identify additional information regarding the product or service.

Searching of vendor sites may be either dynamic or periodic. Because product and service offerings of vendors change frequently, however, preferred embodiments utilize dynamic searching to ensure current purchase option data is collected and presented to users. In some embodiments, search results may be stored in the database 146 for use over a short period of time (e.g., an hour or a day). In some embodiments, vendor site data may be cached by the server 140 for a period of time to reduce delay in accessing the vendor site data, but the server 140 may search the cached data based upon the keywords dynamically each time the keywords are identified. This is particularly advantageous when the same vendor site data will be searched using a plurality of subsets of keywords associated with the same image in response to one user request.

At block 814, the server 140 may generate a dataset of purchase option data or other option data collected from the one or more vendor sites based upon the searched keywords. The dataset may include information regarding purchase options identified in the data obtained from the vendor sites, such as a data table with data entries indicating products or services offered for purchase by the one or more vendors. The dataset may be separately generated for each of a plurality of searches, or the dataset may be iteratively updated with additional purchase option data from subsequent searches. As noted above, the purchase option data identified from each search of the vendor sites may be used to compare alternative sets of keywords. In some embodiments, the number of purchase options identified by the searches may be used to determine the quality of the search (i.e., the salience of the keywords searched). Thus, the purchase option data from low-quality searches may be discarded, in some embodiments, as being unlikely to be of much interest to the user. Alternatively, the purchase options stored in the dataset may be ranked according to the number of searches in which they appear or according to other metrics of relevance.

When multiple subsets of keywords are identified, as discussed above, separate or cumulative datasets may be generated or updated during each iteration. Following such dataset generation or update, the server 140 may determine whether to search another subset of keywords. In some embodiments, the server 140 may search all identified subsets of keywords, thus iteratively searching until all subsets have been used to search the vendor sites. Alternatively, the server 140 may iteratively search the vendor sites using the subsets of keywords until sufficient purchase options are obtained. This may include continuing to iterate through subsets of keywords until a predetermined number of purchase options are identified. Such predetermined number of purchase options may include a predetermined range between a minimum search result threshold and a maximum search result threshold (e.g., between fifteen and twenty purchase options). Fewer purchase options may indicate the keywords are too specific or irrelevant, while excess purchase options may indicate that the keywords are too general or broad to specifically identify relevant products or services. The predetermined number of purchase options expected by a sufficient search may depend upon the type of product, service, or object.

Until the generated dataset is determined to be sufficient, the server 140 may continue to iterate through additional sets or subsets of keywords. This may include identifying a new set of keywords at block 804 or, in some embodiments, further filtering the keywords at block 806. Such further filtering may be adaptive based upon the purchase option data obtained from previous searches, such as by using a machine learning algorithm to identify adjustments to the sets of keywords. Each subsequent set of keywords may be similarly used to search the vendor sites, and the results evaluated. When the resulting purchase option data in the dataset are determined to be sufficient (or when all sets of keywords have been searched), the identified purchase options (or a subset thereof) may be presented to the user for review and selection. In some embodiments, the generated dataset may be stored for training of machine learning algorithms or for subsequent user requests (e.g., where the same or different user requests product or service purchase options related to the same image, such as an image from a web site 210 or media feed 220). In further embodiments, in order to efficiently utilize system communication and processing resources, the stored dataset may be used if the same image is again indicated by the same or a different user. The images may be identified as identical by comparison of checksums calculated for the images, thereby efficiently allowing the server 140 to determine whether the images are identical.

At block 816, the server 140 may present a plurality of purchase options for identified products or services to the user. In some embodiments, the server 140 may rank the purchase options by relevance, such as based upon the number of keywords associated with the purchase option or the number of times the purchase option was identified in a plurality of searches. In further embodiments, order options may be presented to the user along with the purchase options. Such order options may be determined based upon a genre associated with the products or services. Order options may be presented either for all the purchase options together or separately for each purchase option. In further embodiments, the server 140 may utilize data from previous user purchases or from a user profile to automatically set default values for purchase options, which may be subsequently changed by the user.

The purchase options may be presented to the user in order of relevance. In further embodiments, a subset of the purchase options may be selected for presentation to the user. Seller or service provider identity may be used to select or order the purchase options. For example, purchase options associated with a reputable vendor or a vendor having favorable customer reviews may be preferred over unknown or lower-rated vendors. This may include preferring vendors with which a relationship has been previously established. In yet further embodiments, related products or services from known vendors may be added to the purchase options for presentation to the user based upon the keywords or the search results, such as substitute or complementary products or services. Such additional purchase options may be of benefit to the user in expanding the results. In yet further embodiments, information regarding the user or the user's purchase preferences may be used in determining the purchase options to be presented to the user or the order in which to present the purchase options. For example, user brand preferences from previous purchases or user location may be used to reorder the purchase options for presentation in an order most likely to be useful to the user. In some embodiments, a map showing locations of vendors associated with the purchase options may be presented to the user.

Nonetheless, the user may wish to modify the search manually in some instances. Some embodiments may enable the user to perform such manual modification of the search by presenting a search modification option. At block 818, in some embodiments, the user may use such a search modification option to indicate a modification to the search. Such modification may include an addition of a user-entered keyword or a deletion of a keyword from a set of keywords presented to the user. Such modification may similarly include a user indication of a potion of the original image associated with a particular object of interest. In some embodiments, the user may further select an additional image to be searched together with the original image. Regardless of the manner in which the user indicates a modification of the search, the server 140 may proceed to identify a new or modified set of keywords at block 804, from which new purchase options may be identified and presented to the user.

When the user selects a purchase option at block 820, the server 140 may proceed to facilitate the purchase of the selected product or service at block 822. Facilitating the purchase order may include presenting order options associated with the product or service, which may be identified based upon the purchase option data obtained from the vendor sites or may be identified from a genre associated with the search. The server 140 may obtain the requisite information and communicate with the vendor to complete the purchase, or the server 140 may transfer the user to a vendor server 260 to complete the purchase. The process 800 may then terminate.

FIG. 9 illustrates a flow diagram of an exemplary genre-based search method 900 for refining purchase option searches by identifying genres indicating types of objects, products, or services to search. The method 900 may be implemented using the components of the object identification system 100 and in conjunction with any of the other methods discussed herein to identify and present relevant product or service purchase options to a user. The identification and use of genres associated with particular types of products or services further improves the accuracy of the purchase option search results, thereby enabling the server 140 to automatically identify and provide more relevant purchase options to the user. Additionally, the genres further improve the purchase order process by indicating types of order option information needed to facilitate purchase orders for various types of products or services. In some embodiments, the actions performed at the blocks of method 900 may be implemented as a plurality of software modules or routines running on the server 140. The method 900 is exemplary only, and additional, alternative, or fewer actions may be included in alternative embodiments.

The method 900 may begin by obtaining keywords associated with an object in an electronic image (block 902). The keywords may then be compared against a dataset of genre data to identify any matches (block 904). If no genres are found to match the keywords (block 906), the method 900 may terminate. If at least one genre match is found (block 906), the method 900 may next check for multiple genres match the keywords (block 908). If a plurality of genre matches are found (block 908), one of the genres may be selected from the plurality (block 910). Once one genre is identified, in some embodiments, the method 900 may include identifying one or more vendors associated with the genre (block 912). Based upon the identified genre, order options for purchase orders associated with the genre may also be identified (block 914). The order options may be used in conjunction with purchase option data to facilitate purchases by a user, as discussed elsewhere herein.

At block 902, the server 140 may obtain or identify keywords associated with an object represented within an image, such as an image received from a user. The keywords may be identified as described elsewhere herein. Where a plurality of sets of keywords are to be searched, as described above, the keywords of each set may be obtained and evaluated separately or together, in various embodiments.

At block 904, the server 140 may compare the keywords with a dataset of genre data. The genre data may include one or more data tables or mappings relating keywords with genres, which may be stored in the database 146. The genre data may include probabilistic or deterministic rules for associating an object of interest with a genre (such as a class of products or services) based upon the presence or absence of certain keywords. Genres may be useful in guiding or grouping search results, as well as in determining order options associated with products or services. Therefore, genres may be identified and recorded in the dataset of genre data. In some embodiments, the genre dataset may be generated automatically from previous searches. For example, data scraped from vendor sites may be analyzed using machine learning techniques (e.g., support vectors or neural networks) to identify relationships between keyword groupings. Such groupings may, in some instances, be automatically associated with types of products or services by training algorithms using additional data or metadata from the vendor sites. Alternatively, the groupings may be manually identified. Regardless of the manner of generating the dataset, the genres therein may be matched with the keywords by the server 140 by automated comparison of the keywords and the terms associated with the genres in the dataset, which may involve the application of rulesets or algorithms.

At block 906, the server 140 may compare the keywords with the genre data to determine whether at least one genre matches the keywords. Such match may occur, for example, when core keywords match the corresponding terms in the dataset for at least one genre or when a sufficient number of keywords match the terms associated with a genre. In some embodiments, the match may be determined probabilistically by assigning a probability of a match to each genre based upon analysis of the keywords using one or more algorithms. A match may be determined to exist when the probability exceeds a matching threshold (e.g., 60% or 80%). If no match is identified by the server 140, the method 900 may terminate, and the purchase option search and presentation methods may proceed without using any genres.

At block 908, the server 140 may determine whether the keywords match more than one genre in the dataset of genre data. Such condition may occur, for example, when the keywords include significant terms from multiple genres or where multiple genres are assigned probabilities about a matching threshold. Such condition may also occur in the case of related genres, such as a subgenre of a more general genre. Subgenres may provide greater detail regarding products or services and may improve the search quality when identifiable. For example, tennis shoes and dress shoes may both be subgenres of the genre for shoes. The genre may include information relevant to both subgenres, including indications of vendor sites associated with both subgenres. When a search can be confined to a subgenre, however, the results may be improved, such as by avoiding searching both tennis shoe sellers and dress shoe sellers. If a plurality of genre matches are identified at block 908, the server 140 may select the most relevant genre from among the matches at block 910. Selecting the most relevant genre may include selecting a subgenre of a more general genre, selecting the genre with the highest probability, or selecting the genre with the most matches keywords. Once one genre is identified, the method 900 may continue by identifying vendors or order options associated with the genre.

At block 912, in some embodiments, the server 140 may identify one or more vendor sites associated with the genre. Each vendor site may be associated with a vendor server 260 to be searched using the keywords, as discussed elsewhere herein. The genres may identify the vendor sites most relevant to the type of products or services indicated by the keywords. For example, the genres may identify parts of vendor web sites associated with types of products. By limiting search to the relevant portions of web sites of relevant vendors, the efficiency of the search is improved by increasing the search accuracy and reducing the search time.

At block 914, the server 140 may identify any order options associated with the genre. In some instances, no order options may be associated with the genre, in which case the method 900 may terminate. If the genre is associated with one or more order options, the server 140 may further use the identified order options in presenting product or service purchase options to the user or in facilitating purchase order processing, as discussed elsewhere herein. The order options may indicate customizations associated with products or services in the genre, such as clothing size or electronic device storage capacity. Order options associated with products may include shipping or delivery details, while order options associated with services may include appointment scheduling. Some genres may include both product and service aspects, such as large appliances, which may involve product options (e.g., tank capacity options) and installations options (e.g., scheduling or warranty options). In some embodiments, order options may further include information regarding additional products or services to purchase, such as connectors, batteries, or delivery services to complement the product or service selected by the user. In yet further embodiments, the order options may include discounts or advertisements to present to a user for alternative products. Such order options may be presented to the user to provide comparisons or inform the user of alternatives not otherwise known to the user. Regardless of the type, order options may be presented to the user along with the purchase options or once a purchase option has been selected to facilitate a purchase order, as discussed elsewhere herein.

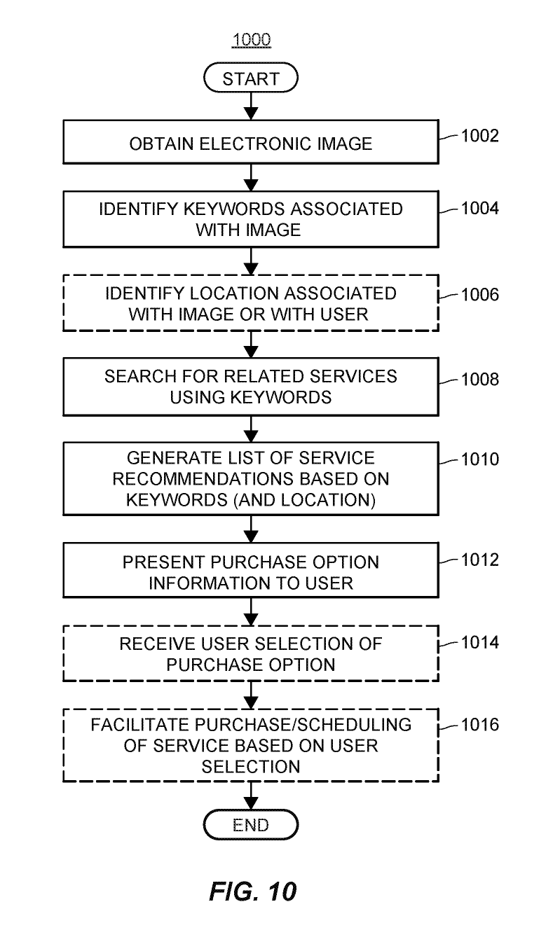

FIG. 10 illustrates a flow diagram of an exemplary service identification method 1000 for identifying purchase options regarding services associated with objects in electronic images. The method 1000 may be implemented using the components of the object identification system 100, either separately or in conjunction with any of the other methods disclosed herein. By identifying relevant keywords based upon objects in images selected by users, the method 1000 improves search accuracy and enables the server 140 to automatically identify and present information regarding relevant services to the user. In contrast to existing methods of identifying service purchase options that require the user to identify the type of service, which is then searched, the exemplary method 1000 automatically identifies services based upon their connections to objects identified within an electronic image. This improves search efficiency, reduces the cognitive and input burden on the user, and promotes the discovery of useful services previously unknown to the user. In some embodiments, the actions performed at the blocks of method 1000 may be implemented as a plurality of software modules or routines running on the server 140. The method 1000 is exemplary only, and additional, alternative, or fewer actions may be included in alternative embodiments.

The method 1000 may begin with obtaining an electronic image to be processed (block 1002). The image (or a part thereof) may then be analyzed to obtain keywords associated with the object (block 1004). In some embodiments, the method 1000 may also identify a location associated with the image or the user (block 1006). Once the keywords are determined, related services may be identified by searching databases or vendor sites using the keywords (and, if available, using the location information) (block 1008). From the results of such searching, a list of service recommendations may be generated (block 1010) and presented to the user (block 1012). In some embodiments, the method 1000 may further include receiving a selection of a purchase option from the user (block 1014) and facilitating a purchase or scheduling of the selected service based upon the user selection (block 1016).

At block 1002, the server 140 may obtain an electronic image indicated by a user of a client computing device 110. Upon receiving the image, the server 140 may further identify keywords associated with the image at block 1004. Identifying a set of keywords may include obtaining labels associated with the keywords from one or more image services 240, as discussed elsewhere herein. Unlike keywords associated with product searches, the keywords associated with services may be more heavily skewed towards context labels or keywords associated therewith. For example, labels indicating snow or a crowd may be of limited relevance for products, but may be of greater relevance for identifying services associated with snow removal or concerts. Thus, in some embodiments, separate algorithms may be employed to identify and filter keywords for services from those used for products.

At block 1006, in some embodiments, the server 140 may further identify one or more locations associated with the image or with the user. Such locations may include the current location of the user, which may also be the location of the image when the image has been recently captured by the user via the camera 115 of the client computing device 110. The user's current location may be determined based upon the location of the client computing device 113. For example, the user's location may be determined by the geolocation unit 113 of the client computing device 110 and transmitted to the sever 140 via the network 130, or the user's location may be determined with lower accuracy based upon the location of a wireless node (e.g., a cell tower) through which the client computing device 110 is connected to the network 130. One or more locations may instead be determined as locations associated with the user based upon additional information regarding the user, such as a user mailing address from prior purchases or from a user profile stored in the database 146. In some embodiments, the user's location may be identified from a location associated with the electronic image, which may include location (e.g., GPS coordinate) metadata associated with an image captured using the camera 115 of the client computing device 110. The location metadata may be automatically determined and associated with the electronic image by the client computing device 110 using the geolocation component 113, such as by determining and adding GPS coordinates as EXIF data to an electronic image file.

A location may instead be determined for the image separately from locations associated with the user. Such image locations may be identified based upon the image itself, such as by identifying landmarks or signs within the image. In some embodiments, such image-derived location information may be obtained by the server 140 from an image service 240 in response to a request by the server 140. In further embodiments, the server 140 may adjust the identified keywords based upon the identified location information. For example, the identified keywords may be augmented by the addition of keywords indicating the locations, such as place names or landmark descriptions. As another example, the keywords may be filtered based upon services or objects likely to be of particularly high or low relevance to an area. If the keywords are adjusted based upon the location information, the adjusted keywords may further be used to search for service purchase options to be presented to the user.

At block 1008, the server 140 may search vendor sites for services related to the identified keywords, as discussed elsewhere herein. The server 140 may scrape data relating to services from one or more vendor sites to generate a dataset containing purchase options associated with services offered by the vendors. In some embodiments, the vendor sites may be identified or the search may be performed using information associated with genres of services. Because services are typically more dependent upon location than products, the vendor sites searched may be determined at least partially based upon locations, when such information is available. For example, vendor sites may be searched only for vendors operating in a geographic area (e.g., a state or metropolitan area) indicated by the identified location. Alternatively, the server 140 may scrape location information for services from vendor sites already determined to be associated with identified purchase options based upon the keywords. In embodiments utilizing location information, the services identified may be limited to locations near the locations associated with the user, thereby avoiding the necessity to travel to service locations. In some such embodiments, travel services may be avoided in the search results and service purchase options in order to improve the quality of the results.

Regardless of whether location information is used, the server 140 may identify one or more vendor sites to search for service purchase options that match the keywords associated with the image. For example, keywords identifying a musician may be used to search vendor sites for upcoming concerts, or keywords identifying a movie, play, or actor may be used to search vendor sites associated with theaters. In some embodiments, the keywords may be used to search general news sites for news articles matching the keywords, such as by using a search engine 250. Data from the news items may be scraped and evaluated to determine additional keywords. For example, searching news articles associated with a celebrity may provide information regarding upcoming events involving the celebrity, which may further be used to search vendor sites associated with the upcoming events. Of course, such events may be filtered by location information, when available.

At block 1010, the server 140 may generate a list of service purchase options from the vendor site search results. The list may include a recommendation level or ranking of the services, which may reflect the projected relevance of the service based upon the identified keywords. In some embodiments, the list may be generated using information location to determine service purchase option recommendations. If a service genre has been identified, information associated with the genre may be included in the list, such as order option information.

At block 1012, the server 140 may send one or more service purchase options from the list to the client computing device 110 for presentation to the user (e.g., via the display 112). The purchase options may be presented in an order based upon relevance or location or a combination thereof. In some embodiments, a map showing locations of vendors associated with the purchase options may be presented to the user. Order options associated with the purchase options may also be presented to the user, as discussed elsewhere herein. In some embodiments, the order options may include scheduling options, such as available appointments, show times, or seating options (e.g., sections in a stadium or concert hall). If the user has granted permission to an application or add-on associated with the search operating on the client computer device 110, an electronic calendar or schedule associated with the user may be searched to assist with scheduling. For example, a search application running on the client computing device 110 may identify available appointments that do not conflict with existing appointments in the user's electronic calendar. Additional information regarding the service purchase options, such as service levels, optional services, or service provider reviews or ratings (e.g., ratings by industry associations or by other customers) may be provided to the user to assist with decision-making.

At block 1014, the user may indicate a selection of a service purchase option using the input 114 of the client device 110, which may be sent to the server 140. Upon receiving such indication, the client device 110 or the server 140 may cause further information or order options to be presented to the user, in some embodiments. Once sufficient information has been obtained, the server 140 may facilitate the purchase order or scheduling of the selected service at block 1016, in a manner similar to that discussed elsewhere herein. Facilitating the scheduling or purchase of the service may include communicating with the vendor server 260 or may involve causing the client device 110 to communicate with the vendor server 260. In some embodiments, an appointment associated with the service may be added to the user's electronic calendar. Once the service purchase order or scheduling is complete, the method 1000 may terminate.

Throughout this specification, plural instances of components, operations, or structures may be described as a single instance. Although individual operations of one or more methods are illustrated and described as separate operations, one or more of the individual operations may be performed concurrently, and the operations need not always be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may be implemented using software (code embodied on a non-transitory, tangible machine-readable medium) configuring and controlling computer hardware components. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is configured as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, being an entity that is physically constructed and permanently configured (e.g., hardwired) or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines (e.g., cloud computing). In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. For example, presenting information to a user via a display may include controlling a plurality of pixels or other controllable elements to generate a visual pattern containing representations of text or images.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, as used herein, any reference to “some embodiments” or “embodiments” means that a particular element, feature, structure, or characteristic described in connection with the embodiment is included in at least one embodiment.

Some embodiments may be described using the expressions “communicatively coupled,” “coupled,” or “connected” along with their derivatives. For example, some embodiments may be described using the term “coupled” to indicate that two or more elements are in direct or indirect physical or electrical contact. The term “coupled,” however, may also mean that two or more elements are not in direct contact with each other, but yet still co-operate or interact with each other, such as by exchanging electronic communication signals. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. Thus, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention. By way of example, and not limitation, the present disclosure contemplates at least the following aspects:

1. A computer-implemented method of facilitating electronic commerce by automated image-based searching, comprising: obtaining, by one or more processors, an electronic image including a representation of an object within the image; identifying, by one or more processors, a plurality of labels associated with the image, wherein at least one of the labels is associated with the object; identifying, by one or more processors, a plurality of keywords associated with the electronic image based upon the plurality of labels; generating, by one or more processors, a purchase option dataset containing a plurality of data entries indicating purchase options based upon the plurality of keywords, each purchase option being associated with a service; and/or causing, by one or more processors, one or more of the purchase options indicated by the data entries to be presented to a user for review.

2. The computer-implemented method according to aspect 1, further comprising: identifying, by one or more processors, a location associated with the user; and selecting, by one or more processors, the one or more purchase options to be presented to the user based upon the identified location.

3. The computer-implemented method according to aspect 2, wherein identifying the location associated with the user includes identifying a location associated with the electronic image based upon location metadata associated with the electronic image.

4. The computer-implemented method according to any one of aspects 1-3, further comprising: identifying, by one or more processors, a location associated with the user; identifying, by one or more processors, one or more vendor sites associated with vendors providing services within a geographic area associated with the location; and searching, by one or more processors, the one or more vendor sites for information regarding the service to identify the one or more purchase options.

5. The computer-implemented method according to any one of aspects 1-4, further comprising: identifying, by one or more processors, a type of the object based upon the plurality of labels, wherein at least one of the labels is an image object label describing the object; and wherein generating the purchase option dataset includes: searching one or more vendor sites for information regarding services associated with the identified type of the object; and storing at least part of the information regarding the services from the one or more vendor sites in the purchase option dataset.

6. The computer-implemented method according to aspect 5, further comprising: receiving, at one or more processors, an indication from the user of a location within the electronic image, the location being associated with the object, and wherein the object is identified at least in part based upon a user selection of a location within the image.

7. The computer-implemented method according to any one of aspects 1-6, wherein the services include one or more of the following types of services: entertainment services, maintenance services, or personal services.

8. The computer-implemented method according to any one of aspects 1-7, further comprising: receiving, at one or more processors, an indication of a user selection of one of the one or more purchase options; and communicating, by one or more processors, a message based upon the user selection to a vendor server associated with the purchase option indicated by the user selection to cause a service appointment to be scheduled for the user.

9. A computer system for facilitating electronic commerce by automated image-based searching, comprising: one or more processors; a program memory storing executable instructions that, when executed by the one or more processors, cause the computer system to: obtain an electronic image including a representation of an object within the image; identify a plurality of labels associated with the image, wherein at least one of the labels is associated with the object; identify a plurality of keywords associated with the electronic image based upon the plurality of labels; generate a purchase option dataset containing a plurality of data entries indicating purchase options based upon the plurality of keywords, each purchase option being associated with a service; and/or cause one or more of the purchase options indicated by the data entries to be presented to a user for review.

10. The computer system according to aspect 9, wherein the executable instructions further cause the computer system to: identify a location associated with the user; and select the one or more purchase options to be presented to the user based upon the identified location.

11. The computer system according to either of aspect 9 or aspect 10, wherein the executable instructions further cause the computer system to: identify a location associated with the user; identify one or more vendor sites associated with vendors providing services within a geographic area associated with the location; and search the one or more vendor sites for information regarding the service to identify the one or more purchase options.

12. The computer system according to any one of aspects 9-11, wherein: the executable instructions further cause the computer system to identify a type of the object based upon the plurality of labels, wherein at least one of the labels is an image object label describing the object; and the executable instructions that cause the computer system to generate the purchase option dataset include executable instructions that cause the computer system to: search one or more vendor sites for information regarding services associated with the identified type of the object; and store at least part of the information regarding the services from the one or more vendor sites in the purchase option dataset.

13. The computer system according to any one of aspects 9-12, wherein: the executable instructions further cause the computer system to receive an indication from the user of a location within the electronic image, the location being associated with the object; and the object is identified at least in part based upon a user selection of a location within the image.

14. The computer system according to any one of aspects 9-13, wherein the executable instructions further cause the computer system to: receive an indication of a user selection of one of the one or more purchase options; and communicate a message based upon the user selection to a vendor server associated with the purchase option indicated by the user selection to cause a service appointment to be scheduled for the user.

15. A tangible, non-transitory computer-readable medium storing instructions that, when executed by one or more processors of a computer system, cause the computer system to: obtain an electronic image including a representation of an object within the image; identify a plurality of labels associated with the image, wherein at least one of the labels is associated with the object; identify a plurality of keywords associated with the electronic image based upon the plurality of labels; generate a purchase option dataset containing a plurality of data entries indicating purchase options based upon the plurality of keywords, each purchase option being associated with a service; and/or cause one or more of the purchase options indicated by the data entries to be presented to a user for review.

16. The tangible, non-transitory computer-readable medium according to aspect 15, further storing executable instructions that cause the computer system to: identify a location associated with the user; and select the one or more purchase options to be presented to the user based upon the identified location.

17. The tangible, non-transitory computer-readable medium according to either of aspect 15 or aspect 16, further storing executable instructions that cause the computer system to: identify a location associated with the user; identify one or more vendor sites associated with vendors providing services within a geographic area associated with the location; and search the one or more vendor sites for information regarding the service to identify the one or more purchase options.

18. The tangible, non-transitory computer-readable medium according to any one of aspects 15-17, further storing executable instructions that cause the computer system to identify a type of the object based upon the plurality of labels, wherein at least one of the labels is an image object label describing the object, and wherein the executable instructions that cause the computer system to generate the purchase option dataset include executable instructions that cause the computer system to: search one or more vendor sites for information regarding services associated with the identified type of the object; and store at least part of the information regarding the services from the one or more vendor sites in the purchase option dataset.

19. The tangible, non-transitory computer-readable medium according to any one of aspects 15-18, further storing executable instructions that cause the computer system to receive an indication from the user of a location within the electronic image, the location being associated with the object, and wherein the object is identified at least in part based upon a user selection of a location within the image.

20. The tangible, non-transitory computer-readable medium according to any one of aspects 15-19, further storing executable instructions that cause the computer system to: receive an indication of a user selection of one of the one or more purchase options; and communicate a message based upon the user selection to a vendor server associated with the purchase option indicated by the user selection to cause a service appointment to be scheduled for the user.

What is claimed is:

1. A computer-implemented method, comprising:
obtaining, by one or more processors, an electronic image including a representation of an object within the image;
identifying, by one or more processors, a plurality of labels associated with the image, wherein at least one of the labels is associated with the object;
identifying, by one or more processors, a plurality of keywords associated with the electronic image based upon the plurality of labels;
generating, by one or more processors, an option dataset containing a plurality of data entries indicating options based upon the plurality of keywords, each option being associated with a service; and
causing, by one or more processors, one or more of the options indicated by the data entries to be presented to a user for review.

2. The computer-implemented method of claim 1, further comprising:
identifying, by one or more processors, a location associated with the user; and
selecting, by one or more processors, the one or more options to be presented to the user based upon the identified location.

3. The computer-implemented method of claim 2, wherein identifying the location associated with the user includes identifying a location associated with the electronic image based upon location metadata associated with the electronic image.

4. The computer-implemented method of claim 1, further comprising:
identifying, by one or more processors, a location associated with the user;
identifying, by one or more processors, one or more vendor sites associated with vendors providing services within a geographic area associated with the location; and
searching, by one or more processors, the one or more vendor sites for information regarding the service to identify the one or more options.

5. The computer-implemented method of claim 1, further comprising:
identifying, by one or more processors, a type of the object based upon the plurality of labels, wherein at least one of the labels is an image object label describing the object; and
wherein generating the option dataset includes:
searching one or more vendor sites for information regarding services associated with the identified type of the object; and
storing at least part of the information regarding the services from the one or more vendor sites in the option dataset.

6. The computer-implemented method of claim 5, further comprising:
receiving, at one or more processors, an indication from the user of a location within the electronic image, the location being associated with the object, and
wherein the object is identified at least in part based upon a user selection of a location within the image.

7. The computer-implemented method of claim 1, wherein the services include one or more of the following types of services: entertainment services, maintenance services, or personal services.

8. The computer-implemented method of claim 1, further comprising:
receiving, at one or more processors, an indication of a user selection of one of the one or more options; and
communicating, by one or more processors, a message based upon the user selection to a vendor server associated with the option indicated by the user selection to cause a service appointment to be scheduled for the user.

9. A computer system, comprising:
one or more processors;
a program memory storing executable instructions that, when executed by the one or more processors, cause the computer system to:
obtain an electronic image including a representation of an object within the image;
identify a plurality of labels associated with the image, wherein at least one of the labels is associated with the object;
identify a plurality of keywords associated with the electronic image based upon the plurality of labels;
generate an option dataset containing a plurality of data entries indicating options based upon the plurality of keywords, each option being associated with a service; and
cause one or more of the options indicated by the data entries to be presented to a user for review.

10. The computer system of claim 9, wherein the executable instructions further cause the computer system to:
identify a location associated with the user; and
select the one or more options to be presented to the user based upon the identified location.

11. The computer system of claim 9, wherein the executable instructions further cause the computer system to:
identify a location associated with the user;
identify one or more vendor sites associated with vendors providing services within a geographic area associated with the location; and
search the one or more vendor sites for information regarding the service to identify the one or more options.

12. The computer system of claim 9, wherein:
the executable instructions further cause the computer system to identify a type of the object based upon the plurality of labels, wherein at least one of the labels is an image object label describing the object; and
the executable instructions that cause the computer system to generate the option dataset include executable instructions that cause the computer system to:
search one or more vendor sites for information regarding services associated with the identified type of the object; and
store at least part of the information regarding the services from the one or more vendor sites in the option dataset.

13. The computer system of claim 9, wherein:
the executable instructions further cause the computer system to receive an indication from the user of a location within the electronic image, the location being associated with the object; and
the object is identified at least in part based upon a user selection of a location within the image.

14. The computer system of claim 9, wherein the executable instructions further cause the computer system to:
receive an indication of a user selection of one of the one or more options; and
communicate a message based upon the user selection to a vendor server associated with the option indicated by the user selection to cause a service appointment to be scheduled for the user.

15. A tangible, non-transitory computer-readable medium storing instructions that, when executed by one or more processors of a computer system, cause the computer system to:
obtain an electronic image including a representation of an object within the image;
identify a plurality of labels associated with the image, wherein at least one of the labels is associated with the object;
identify a plurality of keywords associated with the electronic image based upon the plurality of labels;
generate an option dataset containing a plurality of data entries indicating options based upon the plurality of keywords, each option being associated with a service; and
cause one or more of the options indicated by the data entries to be presented to a user for review.

16. The tangible, non-transitory computer-readable medium of claim 15, further storing executable instructions that cause the computer system to:
identify a location associated with the user; and
select the one or more options to be presented to the user based upon the identified location.

17. The tangible, non-transitory computer-readable medium of claim 15, further storing executable instructions that cause the computer system to:
identify a location associated with the user;
identify one or more vendor sites associated with vendors providing services within a geographic area associated with the location; and
search the one or more vendor sites for information regarding the service to identify the one or more options.

18. The tangible, non-transitory computer-readable medium of claim 15, further storing executable instructions that cause the computer system to identify a type of the object based upon the plurality of labels, wherein at least one of the labels is an image object label describing the object, and
wherein the executable instructions that cause the computer system to generate the option dataset include executable instructions that cause the computer system to:
search one or more vendor sites for information regarding services associated with the identified type of the object; and
store at least part of the information regarding the services from the one or more vendor sites in the option dataset.

19. The tangible, non-transitory computer-readable medium of claim 15, further storing executable instructions that cause the computer system to receive an indication from the user of a location within the electronic image, the location being associated with the object, and
wherein the object is identified at least in part based upon a user selection of a location within the image.

20. The tangible, non-transitory computer-readable medium of claim 15, further storing executable instructions that cause the computer system to:
receive an indication of a user selection of one of the one or more options; and
communicate a message based upon the user selection to a vendor server associated with the option indicated by the user selection to cause a service appointment to be scheduled for the user.
